(19) United States
(12) Patent Application Publication
(10) Pub. No.: US 2019/0202075 A1
(43) Pub. Date: Jul. 4, 2019

(54) Multi-Purpose Bayonet Knife Assembly

(71) Applicant: Superspace S&T Manufacture Co., Ltd, Hacienda Heights, CA (US)

(72) Inventor: Ligang Zhao, Hacienda Heights, CA (US)

(21) Appl. No.: 15/864,538

(22) Filed: Jan. 8, 2018

Related U.S. Application Data
(60) Provisional application No. 62/613,607, filed on Jan. 4, 2018.

(51) Int. Cl. B26B 11/00; B26B 9/02; B25F 1/00; G04B 49/02; G01B 3/04; G01C 17/00; F41C 27/18; F23Q 1/06

(52) U.S. Cl. CPC B26B 11/006; B26B 9/02; B25F 1/00; G04B 49/02; F41B 13/08; G01C 17/00; F41C 27/18; F23Q 1/06; G01B 3/04

(57) ABSTRACT

A multi-purpose bayonet knife assembly mounts to the distal end of a firearm barrel to augment the firearm as a pike and detaches to operate as a knife, while also providing integrated utilitarian components having minimal moving parts. The assembly comprises a hilt, a cross guard, and a blade. The hilt has an integral flint and a snap-on hook. The hook detachably couples to the firearm barrel, and also serves to open a bottle. A sleeve houses the hilt. The blade is defined by a longitudinally extending edge defined by: a first serrated edge, a second serrated edge, an angled bevel, and a double-sided blade tip oriented about 30° above the longitudinally extending edge of blade. Blade includes metric and imperial scales, time dial, and compass. Blade forms a dowel hole, nut socket holes, and a longitudinally extending groove. The metallic composition of the blade serves as an antenna.

### CROSS REFERENCE OF RELATED APPLICATIONS

This application claims the benefits of U.S. provisional application No. 62/613,607, filed Jan. 4, 2018 and entitled MULTI-PURPOSE BAYONET KNIFE ASSEMBLY, which provisional application is incorporated by reference herein in its entirety.

### FIELD OF THE INVENTION

The present invention relates generally to a multi-purpose bayonet knife assembly. More so, the present invention relates to a multi-purpose knife bayonet assembly mounts to the distal end of a firearm barrel as a weapon to augment the firearm to allow use as a pike and quickly detaches from the barrel to operate as a knife, while also providing multiple utilitarian components integrated into the blade, so as to minimize moving parts; whereby the bayonet knife assembly comprises a hilt, a cross guard, and a blade; whereby the hilt terminates with a snap-on hook that serves the dual purpose of detachably coupling to the distal end of the firearm barrel, and opening bottles; whereby a sleeve houses the hilt, so as to enhance gripping the bayonet knife assembly; whereby the blade is defined by at least one longitudinally extending edge defined by: a first serrated edge, a second serrated edge, an angled bevel, and a double-sided blade tip that is oriented about 30° above the longitudinally extending edge of the blade; whereby a time dial, compass, and metric and imperial scales are integral in the blade; whereby a dowel hole, at least one nut socket hole, and a longitudinally extending groove form in the blade; whereby the metallic composition of the blade serves as an antenna.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that there are advantageous to mounting an accessory, such as a bayonet, flash suppressor, silencer, grenade launcher, blank adapter, or the like, upon the end of gun barrels. Such accessories are usually mounted upon an adapter which constitutes a coupling for attaching the accessory to the gun barrel. Typically, a bayonet is a bladed weapon similar to a knife or short sword, or spike-shaped weapon designed to fit in, on, over or underneath the muzzle of a rifle, musket or similar firearm, augmenting the firearm to allow use as a pike.

Generally, a knife is a tool with a cutting edge or blade, hand-held or otherwise, and a handle. Knives are used as utensils, including knives used at the dining table (e.g., butter knives and steak knives) and knives used in the kitchen (e.g., paring knife, bread knife, cleaver). Many types of knives are used as tools, such as the combat knife carried by soldiers.

Generally, a utility knife is a knife used for general or utility purposes. The utility knife was originally a fixed blade knife with a cutting edge suitable for general work such as cutting hides and cordage, scraping hides, butchering animals, cleaning fish, and other tasks. Most utility knives are not well suited to use as offensive weapons, with the exception of some outdoor-type utility knives employing longer blades. However, even small razor-blade type utility knives may sometimes find use as slashing weapons.

Other proposals have involved utility knives and bayonets. The problem with these cutting and stabbing tools is that they do not combine a bayonet, a knife, and a utility knife. Also, there are numerous moving parts that complicate the cutting device. Even though the above cited cutting and stabbing tools meet some of the needs of the market, a multi-purpose bayonet knife assembly that detachably mounts to the distal end of a firearm barrel as a weapon to augment the firearm, quickly detaches from the firearm barrel to operate as a knife, and also provides multiple utilitarian components integrated into the blade, so as to minimize moving parts, is still desired.

### SUMMARY

Illustrative embodiments of the disclosure are generally directed to a multi-purpose bayonet knife assembly. The multi-purpose bayonet knife assembly detachably mounts to the distal end of a firearm barrel as a weapon to augment the firearm, so as to allow use as a pike, and quickly detaches from the firearm barrel to operate as a knife. The bayonet knife assembly also provides multiple utilitarian components integrated into the blade, so as to minimize moving parts. In this manner, the bayonet knife assembly not only provides cutting, sawing, and chopping functionalities, but also provides numerous other utility components, such as guidance capabilities, fire ignition, time, linear measurements, nut tightening and loosening, scissor sharpening, and antenna capabilities, which creates a multi-purpose bayonet knife assembly.

In one non-limiting embodiment, the bayonet knife assembly comprises a hilt, a cross guard, and a blade. The hilt, or hollow handle, is defined by a hilt distal end and a hilt proximal end. The hilt distal end comprises a snap-on hook that serves the dual purpose of detachably coupling to the distal end of the firearm barrel, and providing leverage to open bottles, cans, and the like. The hilt further contains an integral flint that can be used to start fires. The flint A sleeve may be used to house the hilt, so as to enhance gripping the bayonet knife assembly.

The blade forms at least one longitudinally extending edge defined by a blade proximal end, a blade distal end, a first serrated edge, a second serrated edge, an angled bevel, and a double-sided blade tip forming at the blade distal end. The double-sided blade tip is oriented about 30° above the longitudinally extending edge of the blade. The blade proximal end comprises an integral time dial and compass. Further, the blade forms a dowel hole for sharpening a scissor, at least one nut socket hole for tightening nuts and bolts, and a longitudinally extending groove for carrying blood or other liquids from the blade proximal end to the blade tip. The cross guard serves as a nexus between the hilt and the blade. In yet other embodiments, the metallic composition of the blade and the cross guard may serve as an antenna.

In one aspect, the multi-purpose bayonet knife assembly, comprises:
a hilt having a hilt distal end and a hilt proximal end, the hilt proximal end comprising a snap-on hook, the snap-on hook operable to detachably couple to a distal end of a firearm barrel, the snap-on hook further operable to open a bottle;
a pin, the pin fastening the snap-on hook to the distal end of the firearm barrel, the snap-on hook forming a friction fit relationship with the distal end of the firearm barrel;
a gun clip having a panel forming at least one rectangular through hole, the through hole enabling passage of the pin, the gun clip further having a pinch plate disposed parallel to the panel, the pinch plate retaining the pin in alignment with the through hole, the gun clip further having a compression spring, the compression spring forcing the pin to remain fastened in the through hole, wherein the gun clip is operable with the pin to help fasten the snap-on hook to the distal end of the firearm barrel;
a flint joined with the hilt, the flint operable to ignite a fire;
a sleeve housing the hilt;
a blade having a blade proximal end and a blade distal end, the blade defined by at least one longitudinally extending edge, the longitudinally extending edge having a first serrated edge, a second serrated edge, an angled bevel, and a double-sided blade tip forming at the blade distal end, the double-sided blade tip angled about 30° from the longitudinally extending edge of the blade,
the blade further defined by a dowel hole operable to sharpen a scissor, the blade further defined by at least one nut socket hole operable to engage and rotate a nut, the blade further defined by a longitudinally extending groove operable to carry a liquid from the blade proximal end to the blade distal end,
the blade further defined by a substantially metallic composition, whereby the metallic composition of the blade is operable as an antenna;
a time dial engraved in the blade proximal end;
a compass integrated in the blade proximal end;
a metric scale integrated in the blade;
an imperial scale integrated in the blade; and
a cross guard forming a nexus between the hilt and the blade.

In another aspect, the bayonet knife assembly comprises a pin.

In another aspect, the pin fastens the snap-on hook to the distal end of the firearm barrel.

In another aspect, the distal end of the firearm barrel is defined by an aperture for receiving the snap-on hook.

In another aspect, the snap-on hook forms a friction fit relationship with the distal end of the firearm barrel.

In another aspect, the blade has a first side defined by a linear edge and a second side defined by an arced edge.

In another aspect, the first side comprises the first serrated edge.

In another aspect, the second side comprises the second serrated edge.

In another aspect, the first serrated edge is wider than the second serrated edge.

In another aspect, the time dial is engraved in the blade proximal end of the blade.

In another aspect, the compass is integrated in the blade proximal end of the blade.

In another aspect, the flint comprises a strip of flint.

In another aspect, the at least one nut socket hole is operable to rotate a hexagonal nut and hexagonal bolt head wrench.

In another aspect, the metallic composition of the blade includes at least one of the following: carbon steel, tool steel, alloy steel, stainless steel, titanium, and a metal alloy.

One objective of the present invention is to provide a bayonet knife assembly that can be used as a bayonet, a saber, a dagger, or a daily multi-purpose work knife.

Another objective is to enable fast, easy coupling between the snap hook at the hilt proximal end and the barrel of a firearm.

Another objective is to mount the assembly to the distal end of a firearm barrel as a weapon to augment the firearm to allow use as a pike.

Another objective is to provide multiple utility uses with minimal moving parts.

Another objective is to provide two different types of serrated edges for sawing and cutting different objects.

Another objective is to cut firewood, and chop, cut, and saw hard objects.

Yet another objective is to provide a bayonet knife assembly that operates as scissors with scabbard cut wire.

Yet another objective is to measure metric or inch sizes as a gauge.

Yet another objective is to open bottles with the blade tip.

Yet another objective is to start a fire with the flint.

Yet another objective is to use the bayonet knife assembly as an antenna for a gun intelligent module.

Yet another objective is to provide large, medium, and small model specifications of the bayonet knife assembly.

Yet another objective is to enable military personnel to complete a series of life-saving tasks.

Yet another objective is to provide a double-sided blade tip that achieves a spur for a screwdriver to engage and rotate twist a screw, while also enabling the opening of a lid for a metal box, or inserting the blade tip into loose soil.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a side view of a first side of an exemplary multi-purpose bayonet knife assembly, in accordance with an embodiment of the present invention;

FIG. 2 illustrates a side view of a second side of the multi-purpose bayonet knife assembly shown in FIG. 1, in accordance with an embodiment of the present invention;

FIGS. 3A-3D illustrate views of a gun clip, where FIG. 3A shows a top view of an exemplary gun clip, FIG. 3B shows a sectioned view of the gun clip, FIG. 3C shows a perspective view of the gun clip, and FIG. 3D shows a sectioned side view of the gun clip, the section taken along section B-B of FIG. 3B, detailing a through hole and a pinch plate, in accordance with an embodiment of the present invention;

FIG. 4 illustrates a side view of another embodiment of the multi-purpose bayonet knife assembly, showing a ruler etched to the side, in accordance with an embodiment of the present invention;

FIG. 5 illustrates a front edge view of the multi-purpose bayonet knife assembly shown in FIG. 1, in accordance with an embodiment of the present invention; and

FIG. 6 illustrates a blow up view of the multi-purpose bayonet knife assembly shown in FIG. 1, in accordance with an embodiment of the present invention.

Like reference numerals refer to like parts throughout the various views of the drawings.

### DETAILED DESCRIPTION OF THE INVENTION

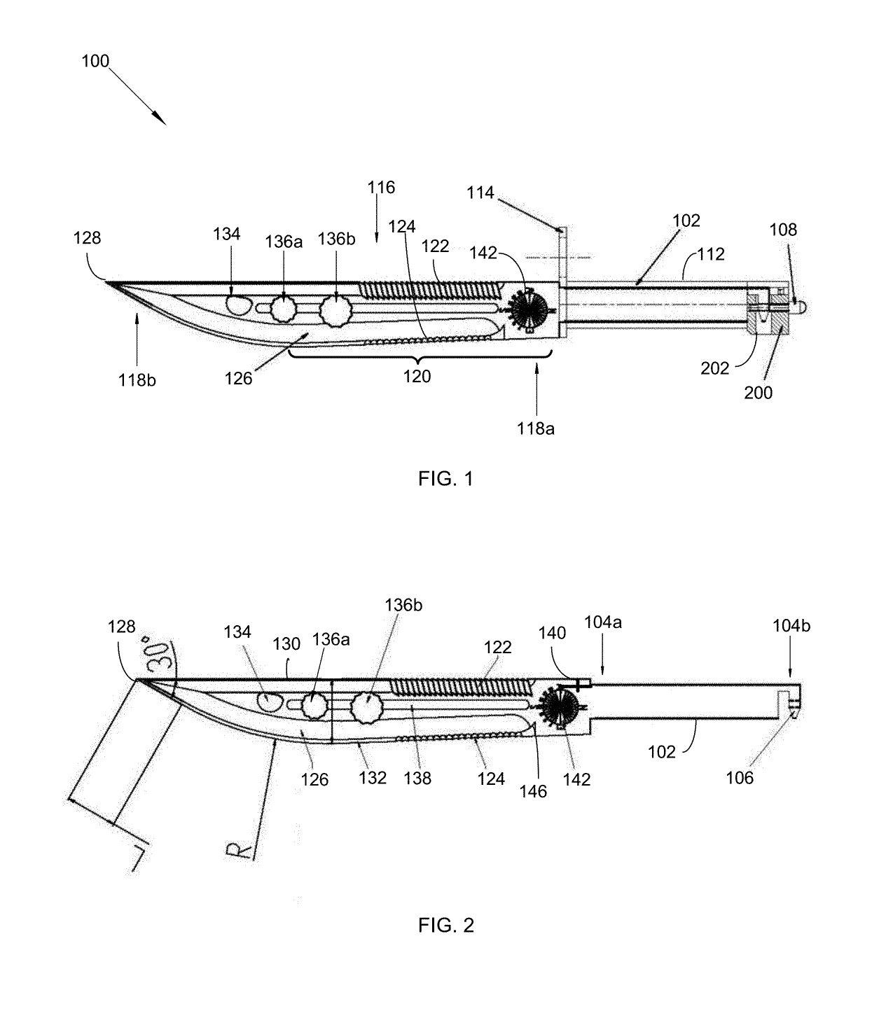

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A multi-purpose bayonet knife assembly 100 is referenced in FIGS. 1-6. The multi-purpose bayonet knife assembly 100, hereafter “assembly 100” provides multiple functions in a single assembly 100; including operation as a bayonet, a knife, and multiple utilitarian components integrated into the blade, so as to minimize moving parts. The utilitarian components offer eclectic functionalities, such as: directional assistance, fire ignition, time, linear measurements, bottle opening, scissor sharpening, and antenna capabilities. Each of these utility capability operates independently of each other, and of the blade's cutting functions.

The assembly 100 is configured to detachably mount to the distal end of a firearm barrel 200 as a weapon to augment the firearm to allow use as a pike. This serves as the bayonet component of the assembly 100. This bayonet feature is possible through use of a snap-on hook 106 that enables quick, tools-free attachment to the barrel 200 of the firearm.

Further, the assembly 100 is configured to quickly detach from the firearm barrel 200, and for the blade 116 to operate as a knife. The knife function provides a longitudinally extending edge 120 for cutting, sawing, and chopping: including a first and second serrated edge 122, 124, a linear sharp edge 130, an arced edge 132, a beveled edge 126, and a double-sided blade tip 128 that is angled about 30° from the longitudinally extending edge 120 of the blade 116. The blade 116 forms a longitudinally extending groove 138 that is utilized to carry liquids away from the blade proximal end 118a, and to the blade tip 128. Thus, the assembly 100 provides cutting, sawing, and chopping functionalities.

Further, the assembly 100 provides numerous other utility components, which are engraved or integral with the blade 116 and hilt 102, so as to minimize moving parts. These utility components provide the functions of: directional assistance, fire ignition, time, linear measurements, bottle opening, scissor sharpening, and antenna capabilities, so as to create a multi-purpose bayonet knife assembly 100.

As FIG. 1 references, the assembly 100 includes a hilt 102 that is used to detachably attach to a distal end of a firearm, such as a rifle. The hilt 102 may also be used for storage and for supporting utility components, described below. In one non-limiting embodiment, the hilt 102 may include a hollow handle that enables both attachment to the firearm as a bayonet, and manipulation with the hand as a utility knife, saw, machete, and the like. In one non-limiting embodiment, the hilt 102 includes a hilt distal end 104a and a hilt proximal end 104b. The hilt proximal end 104b is the end of the hilt 102 that detachably attaches to the barrel 200 of the firearm. For this bayonet attachment function, the hilt proximal end 104b comprises a snap-on hook 106, having a generally U-shape and terminating at multiple ridges.

In one embodiment, the snap-on hook 106 is operable to detachably couple to a distal end of a firearm barrel 200, and specifically an aperture 202 that forms in the barrel 200 of the firearm. Thus, to attach the assembly 100 to the barrel 200, the snap-on hook 106 fits into the aperture 202 that forms in the barrel 200. However in other embodiments, the snap-on hook 106 affixes to any other component or surface area at the distal end of the barrel 200.

Further, as shown in FIG. 2, the generally hook shape of the snap-on hook 106 is operable to open a bottle, can, or other canned item requiring a prying force. This bottle or can-opening function is possible by prying one end of the snap-on hook 106 beneath the bottle or can cap/tab and applying a downward force.

In some embodiments, a pin 108 may be used to help fasten the snap-on hook 106, and thereby the hilt 102, to the distal end of the firearm barrel 200. The pin 108 may pass through an aperture 202 that forms in the firearm barrel 200 to secure the hilt 102 to the barrel. The snap-on hook 106 may also include ridges that form a friction fit relationship in the aperture 202 with the distal end of the firearm barrel 200.

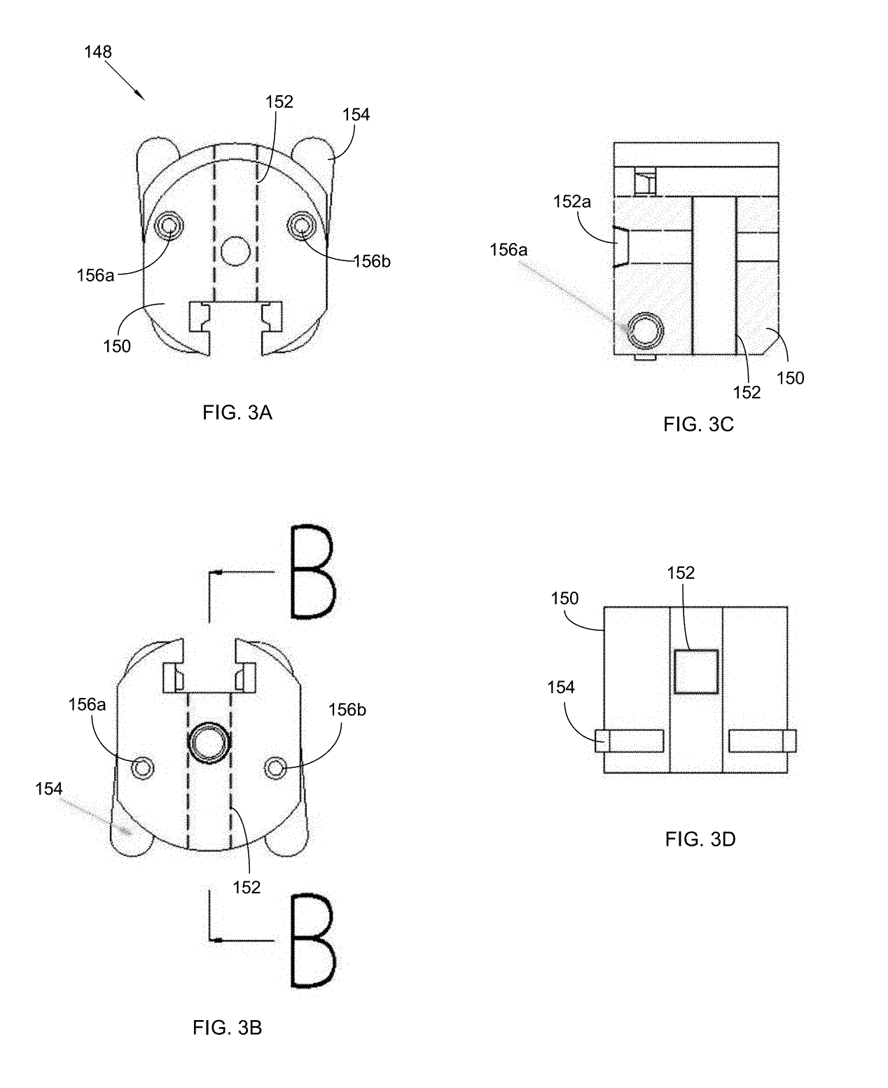

FIGS. 3A-3D illustrate views of a gun clip 148 that helps retain the hilt, and specifically the snap-on hook 106 to the firearm barrel 200. FIG. 3A shows a top view of the gun clip 148; FIG. 3B shows a sectioned view of the gun clip 148; FIG. 3C shows a perspective view of the gun clip 148; and FIG. 3D shows a sectioned side view of the gun clip 148, the section taken along section B-B of FIG. 3B, detailing a through hole 152 and a pinch plate 154.

As shown in FIG. 3A, the gun clip 148 is configured to pressure the snap-on hook 106 against the firearm barrel 200. The gun clip 148 may include a panel 150. The panel 150 is defined by at least one rectangular through hole 152. In one embodiment, shown in FIG. 3B, the through hole 152 has a generally rectangular shape. Though in other embodiments, other shapes may be used. The through holes 152 are sized to enable passage of the snap-on hook 106, or pin 108, or both. The through hole 152 is sized and dimensioned to enable passage of the pin 108.

Looking now at FIG. 3C, the gun clip 148 further includes a pinch plate 154 that is disposed parallel to the panel. The pinch plate 154 is tensioned, so as to retain the pin in alignment and in contact with the through hole. In this manner, the pin is not dislodges from the snap-on hook 106 when being attached or detached to the firearm barrel 200.

As shown in FIG. 3D, the gun clip 148 further includes at least one compression spring 156a, 156b. The rectangular shape of the through hole 152 is also illustrated. The compression spring may enable passage of the pin 108 to help force the pin 108 to remain fastened in the through hole. The compression spring 156a-b may be defined by a spring constant between ranges of 1-5 lb/foot. In this manner, wherein the gun clip 148 is operable with the pin 108 to help fasten the snap-on hook to the distal end of the firearm barrel through a unique clipping action that fits both the snap-on hook 106 and the firearm barrel 200.

However in other embodiments, the snap-on hook 106 affixes to any surface component of the barrel 200. In some embodiments, a sleeve 112 houses the hilt 102. The sleeve 112 may include a resilient or semi-rigid elongated fabric that encapsulates the hilt 102. The sleeve 112 may also provide a gripping surface that enables enhanced manipulation of the assembly 100; when attaching and detaching the blade 116 from the barrel 200, or grasping the hilt 102 to operate the blade 116.

In some embodiments, shown in FIG. 6, a strip of flint 110a, 110b is contained within, or integrated on the hilt 102. The flint 110a-b is operable to ignite a fire. The flint 110a-b may include a hard, sedimentary cryptocrystalline form of the mineral quartz. When struck against steel, the edge of the flint edge produces sparks. The hard flint edge shaves off a particle of the steel that exposes iron, which reacts with oxygen from the atmosphere and can ignite the proper tinder. The flint 110a-b allows the assembly 100 to help a user ignite a fire in a survivor environment.

Looking again at FIG. 2, the assembly 100 also comprises a blade 116 that provides the cutting, sawing, and chopping functionalities of the assembly 100. The blade 116 is configured to serve as a bayonet, a saber, a dagger, and a daily multi-purpose work knife. The blade 116 has a blade proximal end 118a and a blade distal end 118b. The blade distal end 118b is the end that is furthest from the firearm barrel 200. In one non-limiting embodiment, the blade 116 is defined by at least one longitudinally extending edge 120. The longitudinally extending edge 120 may form a first serrated edge 122, a second serrated edge 124, and an angled bevel 126. Though more or less edges are possible in other embodiments.

The blade 116 is further defined by a first side 130 having by a linear configuration and a second side 132 having an arced configuration. The first side 130 of the blade 116 forms a first serrated edge 122, and the second side 132 of the blade 116 forms a second serrated edge 124. Thus, in one possible embodiment, the first serrated edge 122 lies on the linear, first side 130 of the blade 116; and the second serrated edge 124 lies on the arced, second side 132 of the blade 116. Though this may be reversed in other embodiments.

As FIG. 1 illustrates, the first serrated edge 122 is wider and longer than the second serrated edge 124. However both serrated edges 122, 124 are disposed generally towards the blade proximal end 118a. The serrated edges 122, 124 are effective for sawing items, such as wood, wires, or food by moving the serrated edges in a back-and-forth motion across the item. Thus, the serrated edges enable a user to cut firewood, chop, and saw hard objects.

As FIG. 2 references, the blade 116 is further defined by a double-sided blade tip 128 that terminates the blade distal end 118b. The double-sided blade tip 128 is angled about 30° from the longitudinally extending edge 120 of the blade 116. This unique tip angle provides numerous advantages while operating the blade 116. Because of the pointed, angled configuration, the double-sided blade tip 128 forms a spur, acting like a screwdriver to engage and rotate a screw. The double-sided blade tip 128 can also open a lid for a metal box, or be inserted into loose soil.

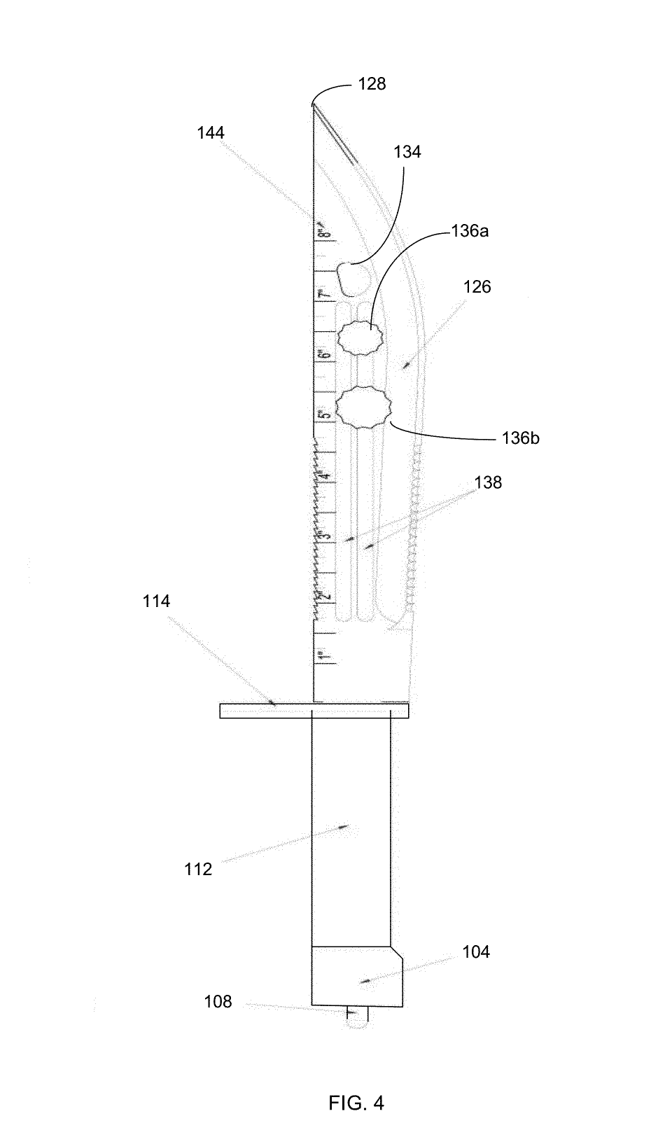

In some embodiments, the blade 116 may be further defined by a dowel hole 134. The dowel hole 134 is operable to sharpen a scissor blade or other sharp surface. The blade 116 is further defined by at least one nut socket hole 136a, 136b that is operable to engage and rotate a nut or a screw with a head. In one embodiment, the nut socket hole 136a-b is operable to rotate a hexagonal nut and hexagonal bolt head wrench. The blade 116 is further defined by a longitudinally extending groove 138 that is operable to carry a liquid from the blade proximal end 118a to the blade distal end 118b. The liquid that is carried along the groove 138 may also include blood that is carried to the blade tip 128. As shown in FIG. 4, two grooves may run parallel to each other.

In one embodiment, the blade 116 is defined by a substantially metallic composition. The metallic composition of the blade 116 is operable to serve as an antenna. Suitable materials for the blade 116 may include, without limitation, carbon steel, tool steel, alloy steel, stainless steel, titanium, and a metal alloy.

Various useful utilities are engraved, or integrated into the blade 116. This may include a time dial 140 that is engraved in the blade proximal end 118a of the blade 116. The time dial 140 may include a sundial that tells the time of day by the apparent position of the sun in the sky. In one non-limiting embodiment, the time dial 140 includes a flat plate (the dial) and a gnomon, which casts a shadow onto the dial. As the sun appears to move across the sky, the shadow aligns with different hour-lines, which are marked on the dial to indicate the time of day.

In other embodiments, a compass 142 is integrated in the blade proximal end 118a of the blade 116. The compass 142 may include an instrument used for navigation and orientation that shows direction relative to the geographic cardinal directions. Usually, a diagram shows the directions north, south, east, and west on the compass face.

In other embodiments, a metric scale 144 is integrated in the blade 116. An imperial scale 146 may also be integrated in the blade 116. The scales enable linear measurements. Both scales 144, 146 help measure linear distances. For example, FIG. 4 illustrates a side view of another embodiment of the multi-purpose bayonet knife assembly, showing a ruler etched to the side.

In one non-limiting embodiment, the assembly 100 comprises a cross guard 114 that forms a nexus between the hilt 102 and the blade 116. The cross guard 114 serves to enhance the grip of the assembly 100, and also restricts the hilt 102 from entering too far into the firearm barrel 200.

In operation, the assembly 100 may be used as a bayonet, a saber, a dagger, and a daily multi-purpose work knife. As a bayonet or dagger the blade 116 can stab or serve as a pike. As a saber, the blade 116 can cut off the offender. As a scissor the serrated edges 122, 124 of the blade 116 can cut wire, cut firewood, chop ingredients, and saw metal hard objects. Further, the blade 116 can be used as a cutting knife to cut rope and other soft objects. The nut socket hole 136a-b is useful as a wrench pull hex nut.

Further, the blade 116 and blade tip 128 may be used as a shovel for loosening shank pit, such as Kai. The tip is double-sided edge, the basic function is to achieve the spur, while both screwdriver for the realization of twist the screw, while easy to achieve open the lid of the metal box, loose soil when the pit is easy to insert into the soil. The blade tip 128 can also open a tin box.

The snap-on hook 106 is useful as a bottle opener to open the lid of a beer bottle or cola bottle. The metric scale 144 and imperial scale 146 measures the metric or inch size as a gauge. The time dial 140 matches the time in the sun as a simple compass 142 for providing the time of day. The flint 110a-b is used to ignite a fire for cooking or heating. Further, the assembly 100 can be used as an antenna for a gun intelligent module.

Furthermore, in order to solve the above problems, this patent discloses a multi-kinetic M11 barracks that can be saved from the most primitive stabs and cuts, as well as working wrenches and shearing tools, and firewood fire. The main part of the M11 slugs, according to the length of the direction of view, according to the function can be divided into the tip of the blade 116, the first half of the blade 116, the second half of the blade 116, hand, knife handle, on the gun card tenon module. The sleeve 112 can be removed from the hilt 102 quickly from the M11 military prod to affix directly to the handle on a robot soldier's arm. The M11 military stab is divided into large, medium and small three models specifications. Even small specifications can be used in performance over the prevailing national mainstream military thorn, large military thorn as a heavy military thorn, the Soviet Union after the victory over the Soviet Union.

The first half of the knife blade 116 on both sides of the edge were linear, two straight edge angle sharp angle, with the smallest resistance to achieve the basic function of assassination and stabbing, one of the two straight edge of the edge of a single edge. One for the double-sided edge, close to the side of the blade 130 side of the blade surface has a through hole, with the installation of the sheath on the hinge shaft to achieve the blade 116 and scabbard with the cut wire, wire and so on. The second half of the blade 132, the side of the arc-shaped edge, the arc edge for the double-sided edge and the first half of the linear double-sided edge smooth through, the arc is mainly used to achieve the basic function of hacking,

The first side 130 is also a linear blade edge covered with saw tooth blade and saw blade, mainly used to achieve the basic function of sawing hard objects, while the knife surface layout of the commonly used plum blossom-shaped. As a hexagonal nut and hexagonal bolt head wrench, the front and back sides of the knife are both metric and imperial scale 144, 146, for the realization of the basic size of the measurement. The blade 116 is also engraved with a time dial 140 and the direction of compass 142, used to achieve the basic orientation of time and daylight.

The main function is to protect the hands of the role, while the top open a hole, the main function is to adapt to the suit arm stab in the front of the flame on the flame arrester, the lower hand there is a hand. The snap-on hook 106 is used to open the beer cap or cola cap. The hilt 102, or knife handle, serves the basic function of the military thorns as a dagger or machetes used for holding, while the handle contains a strip of flint 110a-b, if necessary, to start a fire. On the gun body tenon module, its function is the military thorn on the gun when the fit with the firecrackers of the common dowel hole 134.

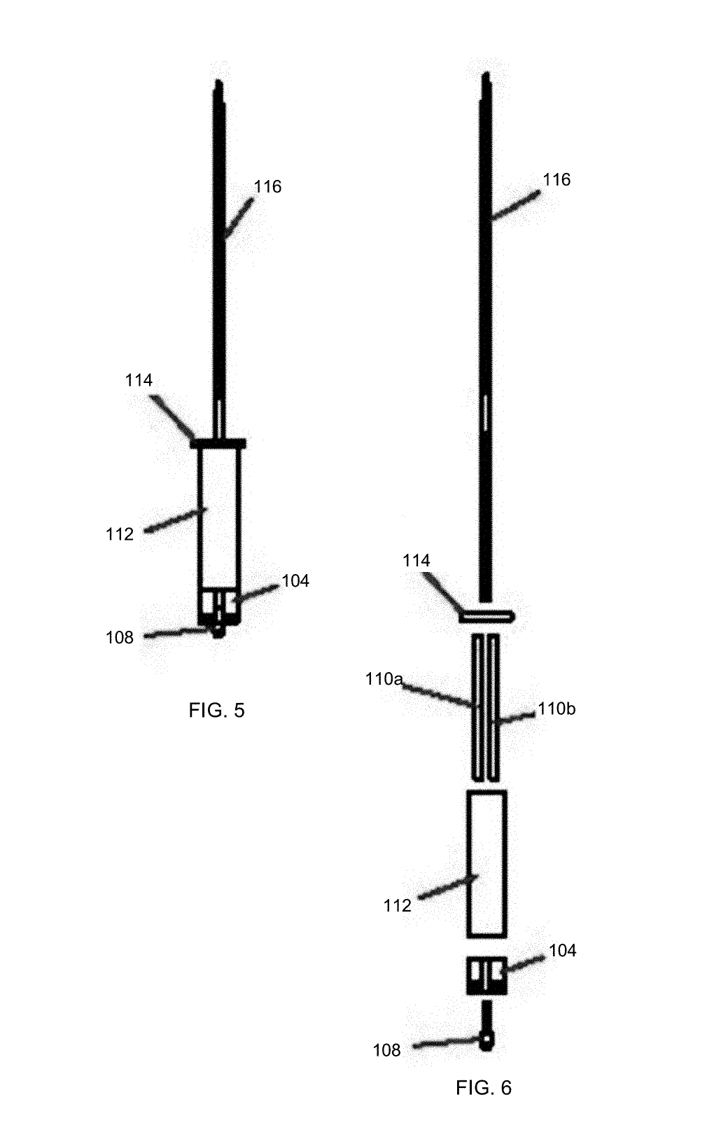

In conclusion, multi-purpose bayonet knife assembly 100 mounts to the distal end of a firearm barrel 200 to augment the firearm as a pike, and also detaches to operate as a knife, while also providing utility uses with minimal moving parts (FIG. 5). The assembly 100 comprises a hilt 102, a cross guard 114, and a blade 116. The hilt 102 has an integral flint 110a-b and a snap-on hook 106. The hook 106 detachably couples to the firearm barrel 200, and also serves to open a bottle or can. A sleeve 112 houses the hilt 102.

The blade 116 is defined by a longitudinally extending edge 120 defined by: a first serrated edge 122, a second serrated edge 124, an angled bevel 126, and a double-sided blade tip 128 oriented about 30° above the longitudinally extending edge 120 of blade 116. The blade 116 includes metric and imperial scales 144, 146, time dial 140, and compass 142. The blade 116 forms a dowel hole 134, at least one nut socket holes 136a, 136b, and a longitudinally extending groove 138. The metallic composition of the blade 116 serves as an antenna.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A multi-purpose bayonet knife assembly, the assembly comprising:
a hilt having a hilt distal end and a hilt proximal end, the hilt proximal end comprising a snap-on hook;
a flint joined with the hilt, the flint operable to ignite a fire;
a sleeve housing the hilt;
a blade having a blade proximal end and a blade distal end, the blade defined by at least one longitudinally extending edge, the longitudinally extending edge having a first serrated edge, a second serrated edge, an angled bevel, and a double-sided blade tip forming at the blade distal end, the double-sided blade tip angled about 30° from the longitudinally extending edge of the blade,
the blade further defined by a dowel hole, the blade further defined by at least one nut socket hole, the blade further defined by a longitudinally extending groove,
the blade further defined by a substantially metallic composition;
a time dial engraved in the blade;
a compass integrated in the blade;
a metric scale integrated in the blade;
an imperial scale integrated in the blade; and
a cross guard forming a nexus between the hilt and the blade.

2. The assembly of claim 1, wherein the snap-on hook is operable to detachably couple to a distal end of a firearm barrel.

3. The assembly of claim 1, wherein the snap-on hook is operable to open a bottle.

4. The assembly of claim 1, wherein the bayonet knife assembly comprises a pin.

5. The assembly of claim 4, further comprising a gun clip having a panel forming a rectangular through hole, the through hole enabling passage of the pin, the gun clip further having a pinch plate disposed parallel to the panel, the pinch plate retaining the pin in alignment with the through hole, the gun clip further having at least one compression spring, the compression spring forcing the pin to remain fastened in the through hole, wherein the gun clip is operable with the pin to help fasten the snap-on hook to the distal end of the firearm barrel.

6. The assembly of claim 5, wherein the snap-on hook forms a friction fit relationship with the distal end of the firearm barrel.

7. The assembly of claim 6, wherein the distal end of the firearm barrel is defined by an aperture for receiving the snap-on hook.

8. The assembly of claim 1, wherein the blade has a first side defined by a linear edge and a second side defined by an arced edge.

9. The assembly of claim 8, wherein the first side of the blade comprises the first serrated edge.

10. The assembly of claim 9, wherein the second side of the blade comprises the second serrated edge.

11. The assembly of claim 1, wherein the first serrated edge is wider than the second serrated edge.

12. The assembly of claim 1, wherein the time dial is engraved in the blade proximal end of the blade.

13. The assembly of claim 1, wherein the compass is integrated in the blade proximal end of the blade.

14. The assembly of claim 1, wherein the flint comprises a strip of flint.

15. The assembly of claim 1, wherein the at least one nut socket hole is operable to enable rotation of a hexagonal nut and a hexagonal bolt head wrench.

16. The assembly of claim 1, wherein the metallic composition of the blade includes at least one of the following: carbon steel, tool steel, alloy steel, stainless steel, titanium, and a metal alloy.

17. The assembly of claim 1, wherein the metallic composition of the blade is operable as an antenna.

18. A multi-purpose bayonet knife assembly, the assembly comprising:
a hilt having a hilt distal end and a hilt proximal end, the hilt proximal end comprising a snap-on hook, the snap-on hook operable to detachably couple to a distal end of a firearm barrel, the snap-on hook further operable to open a bottle;
a pin, the pin fastening the snap-on hook to the distal end of the firearm barrel, the snap-on hook forming a friction fit relationship with the distal end of the firearm barrel;
a gun clip having a panel forming a rectangular through hole, the through hole enabling passage of the pin, the gun clip further having a pinch plate disposed parallel to the panel, the pinch plate retaining the pin in alignment with the through hole, the gun clip further having at least one compression spring, the compression spring forcing the pin to remain fastened in the through hole, wherein the gun clip is operable with the pin to help fasten the snap-on hook to the distal end of the firearm barrel;
a flint joined with the hilt, the flint operable to ignite a fire;
a sleeve housing the hilt;
a blade having a blade proximal end and a blade distal end, the blade defined by at least one longitudinally extending edge, the longitudinally extending edge having a first serrated edge, a second serrated edge, an angled bevel, and a double-sided blade tip forming at the blade distal end, the double-sided blade tip angled about 30° from the longitudinally extending edge of the blade,
the blade further defined by a first side having by a linear configuration and a second side having an arced configuration,
the blade further defined by a dowel hole operable to sharpen a scissor, the blade further defined by at least one nut socket hole operable to engage and rotate a nut, the blade further defined by a longitudinally extending groove operable to carry a liquid from the blade proximal end to the blade distal end,
the blade further defined by a substantially metallic composition, whereby the metallic composition of the blade is operable as an antenna;
a time dial engraved in the blade proximal end of the blade;
a compass integrated in the blade proximal end of the blade;
a metric scale integrated in the blade;
an imperial scale integrated in the blade; and
a cross guard forming a nexus between the hilt and the blade.

19. The assembly of claim 18, wherein the first side of the blade comprises the first serrated edge, and the second side of the blade comprises the second serrated edge.

20. A multi-purpose bayonet knife assembly, the assembly consisting of:
a hilt having a hilt distal end and a hilt proximal end, the hilt proximal end comprising a snap-on hook, the snap-on hook operable to detachably couple to a distal end of a firearm barrel, the snap-on hook further operable to open a bottle;
a pin, the pin fastening the snap-on hook to the distal end of the firearm barrel, the snap-on hook forming a friction fit relationship with the distal end of the firearm barrel;
a gun clip having a panel forming a rectangular through hole, the through hole enabling passage of the pin, the gun clip further having a pinch plate disposed parallel to the panel, the pinch plate retaining the pin in alignment with the through hole, the gun clip further having at least one compression spring, the compression spring forcing the pin to remain fastened in the through hole, wherein the gun clip is operable with the pin to help fasten the snap-on hook to the distal end of the firearm barrel;
a strip of flint joined with the hilt, the flint operable to ignite a fire;
a sleeve housing the hilt;
a blade having a blade proximal end and a blade distal end, the blade defined by at least one longitudinally extending edge, the longitudinally extending edge having a first serrated edge, a second serrated edge, an angled bevel, and a double-sided blade tip forming at the blade distal end, the double-sided blade tip angled about 30° from the longitudinally extending edge of the blade,
the blade further defined by a first side having by a linear configuration and a second side having an arced configuration, the first side of the blade comprising the first serrated edge, and the second side of the blade comprising the second serrated edge,
the blade further defined by a dowel hole operable to sharpen a scissor, the blade further defined by at least one nut socket hole operable to engage and rotate a nut, the blade further defined by a longitudinally extending groove operable to carry a liquid from the blade proximal end to the blade distal end,
the blade further defined by a substantially metallic composition, whereby the metallic composition of the blade is operable as an antenna;
a time dial engraved in the blade proximal end of the blade;
a compass integrated in the blade proximal end of the blade;
a metric scale integrated in the blade;
an imperial scale integrated in the blade; and
a cross guard forming a nexus between the hilt and the blade.
